(19) United States
(12) Patent Application Publication
(10) Pub. No.: US 2014/0336000 A1
(43) Pub. Date: Nov. 13, 2014

(54) Mobile pulley system as interface for rotational engines requiring an external driving force (wheel-based vehicles, turbines, ect.)

(71) Applicant: Stefan Stuparu, Richmond (CA)

(72) Inventor: Stefan Stuparu, Richmond (CA)

(21) Appl. No.: 13/905,483

(22) Filed: Aug. 27, 2013

(51) Int. Cl. B60W 20/00; B60W 10/10; B60W 10/08; B60W 10/12; B60W 10/06

(52) U.S. Cl. CPC B60W 20/10; B60W 10/12; B60W 10/06; B60W 10/08; B60W 10/10
USPC 477/15; 477/115; 477/35

(57) ABSTRACT

The apparatus, comprised of a housing, at least one set of fixed pulleys and corresponding mobile pulleys and the means of controllably coupling the rotational movement to, through and from it reduces the energy required for the self-propelling function of a vehicle employing rotational movement for the said function by at least fifty percent regardless of the said vehicle's internal type of power source and previous amount of energy used for the said function.

### BACKGROUND OF THE INVENTION

The utility's applicability includes or extends into at least the following fields: vehicles using rotational movement for their self-propelling function, power generating devices and mechanical equipment using rotational movement to achieve a desired purpose. The significant problems in these fields are the amount of energy and cost required to operate the vehicles or devices listed immediately above, the impact and cost created by this use of energy upon the environment, and the cost to construct and operate the above-listed vehicles or devices.

### BRIEF SUMMARY OF THE INVENTION

The apparatus is comprised of a plurality of fixed and mobile pulleys and the means for controllably coupling the rotational energy to, through and from the apparatus, within the vehicle or device it is used for. The apparatus reduces the amount of energy required for the self-propelling function of any of the vehicles listed in the “Claims” section, or for the mechanical rotation required for any devices listed in the “Claims” section by at least fifty percent. This reduction in operating energy proportionally reduces the said vehicles or devices' operating and construction costs as well as the magnitude and cost of the environmental impact the said vehicles or devices currently create.

### BRIEF DESCRIPTION OF SEVERAL VIEWS OF THE DRAWING

FIG. 1: Depicts the schematic of a four-wheel drive vehicle.

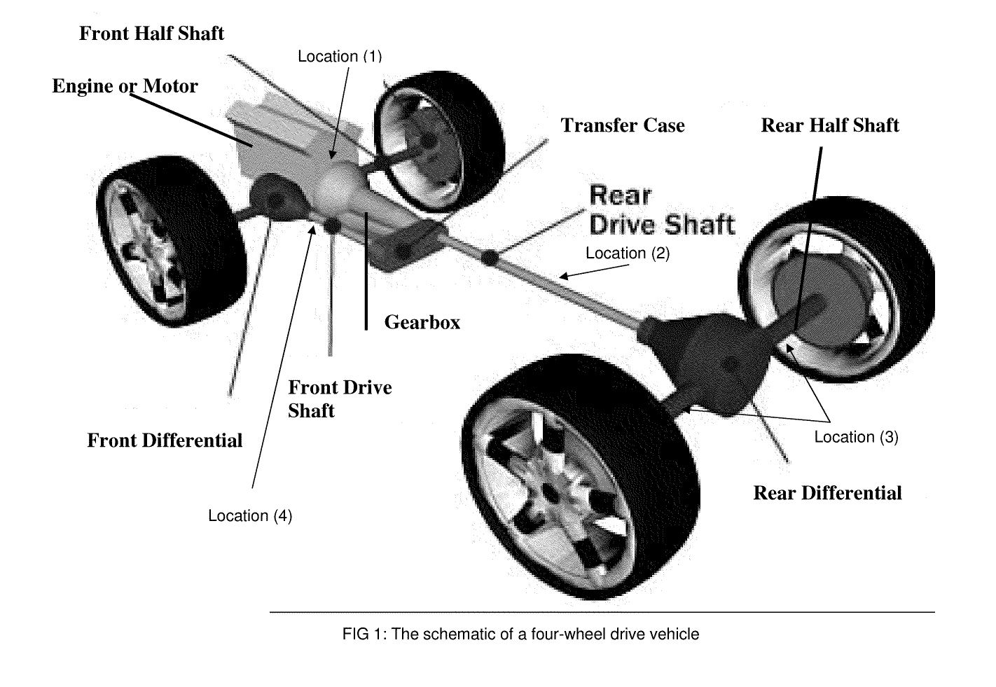

FIG. 2: Depicts the apparatus' front view section installation in location (1)

FIG. 3: Depicts the apparatus' side view section installation in location (1)

FIG. 4: Depicts the apparatus' front view section installation in location (2)

FIG. 5: Depicts the apparatus' front view section installation in location (3)

FIG. 6: Depicts the apparatus' front view section installation in location (4)

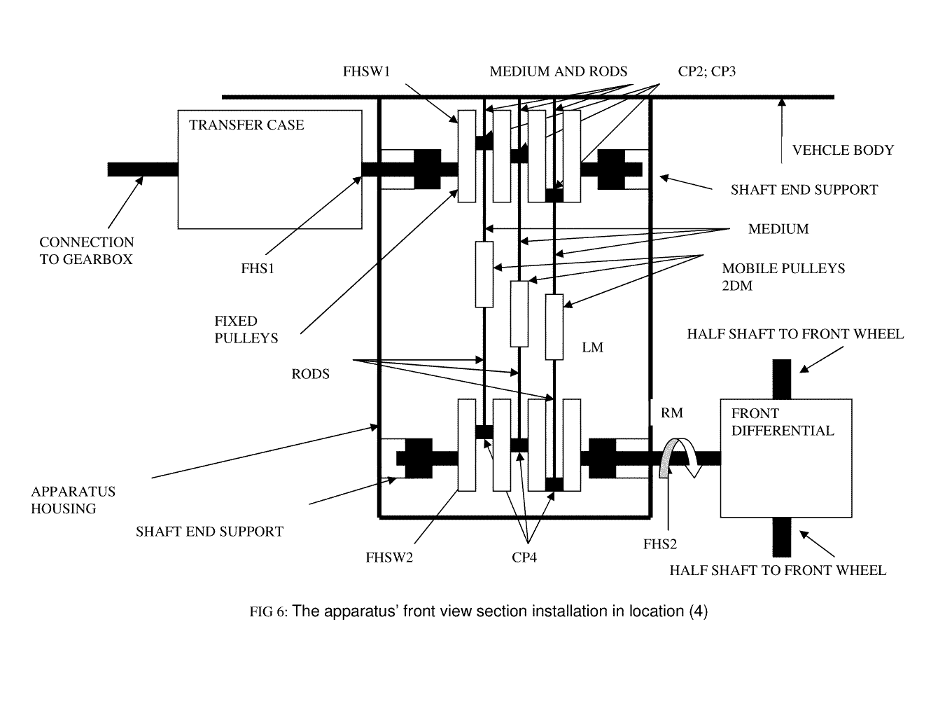

FIG. 7: Depicts the principle of physics governing the operation of mobile pulleys

### DETAILED DESCRIPTION OF THE INVENTION

The utility consists of one apparatus (“apparatus”) or a plurality of apparatuses comprised of fixed and mobile pulleys operating as a force and energy-reducing interface. The apparatus' construction and function is the same for all the applications stated under the individual claims listed in the “Claims” section. For illustration purposes below is the detailed description of the apparatus' function as applicable to internal combustion vehicles. At least one apparatus can be introduced as an interface between (1) the rotating driving shaft of a device or vehicle's engine or motor commonly known as “crankshaft” and the device or vehicle's gearbox, and (2) between a vehicle's gearbox and the “rear differential” of a rear-wheel traction vehicle or otherwise the vehicle's propelling or traction system, and (3) along the rear half shaft between a vehicle's rear differential and each of the rear wheels of the vehicle, and also (4) between a vehicle's gear box “transfer case” and the vehicle's “front differential.” The apparatus reduces the force and thus the energy required to rotate the vehicle's rear traction wheels or otherwise the vehicle's propelling or traction system by at least 50% (fifty percent) of that required prior to the installation of the apparatus.

### Utility's Principle of Operation

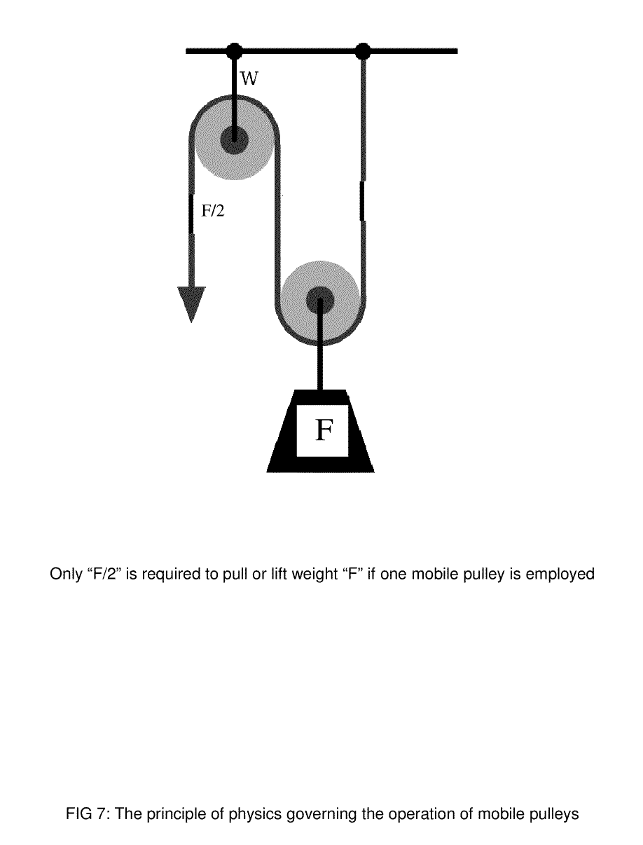

The principle of physics governing the operation of mobile pulleys proves that one mobile pulley reduces by 50% (fifty percent) the force otherwise required to pull, move, or, as required for the purposes of this utility, rotate an object. See FIG. 7. As a result, the force and energy required of the vehicle's engine or motor to achieve the same rotation previously required of the vehicle's traction wheels or rotational propelling system decreases: by at least 50% (fifty percent) with at least one apparatus installed in location “(1)” described above, by at least an additional 50% (fifty percent) with at least one apparatus installed in location “(2)” or (4) described above, and by at least an additional 50% with at least one apparatus installed in location (3). As a result, the cumulative effect of the apparatuses' introduction into the three above-mentioned locations amounts up to 87.5% (eighty seven point five percent) the rotational force or energy previously required for the said vehicle's self-propelling function.

### The Utility's Process of Making and Manner of Use

The apparatus is comprised of at least one housing rigidly connected to the vehicle or device's body, a plurality of fixed pulleys and a corresponding plurality of mobile pulleys. The fixed pulley is comprised of a plurality of independently-rotating wheels whose purpose is to support the transmission “medium” necessary to convey the rotational movement through and over the mobile pulley set. The transmission medium can be a cable, chain or otherwise flexible material suitable for the purpose required. One medium is required for each of the fixed pulley wheels and corresponding mobile pulleys' wheels. For illustration purposes, the following describes the manner and process of making and use for a apparatus consisting of three-wheel fixed pulley and three corresponding mobile pulleys. The manner and process of making and use of the apparatus is the same for any plurality of fixed and mobile pulleys required and for any of the apparatus' applications as described in each claim under the “Claims” section.

### Process of Making the Apparatus for Use into Location “(1)”

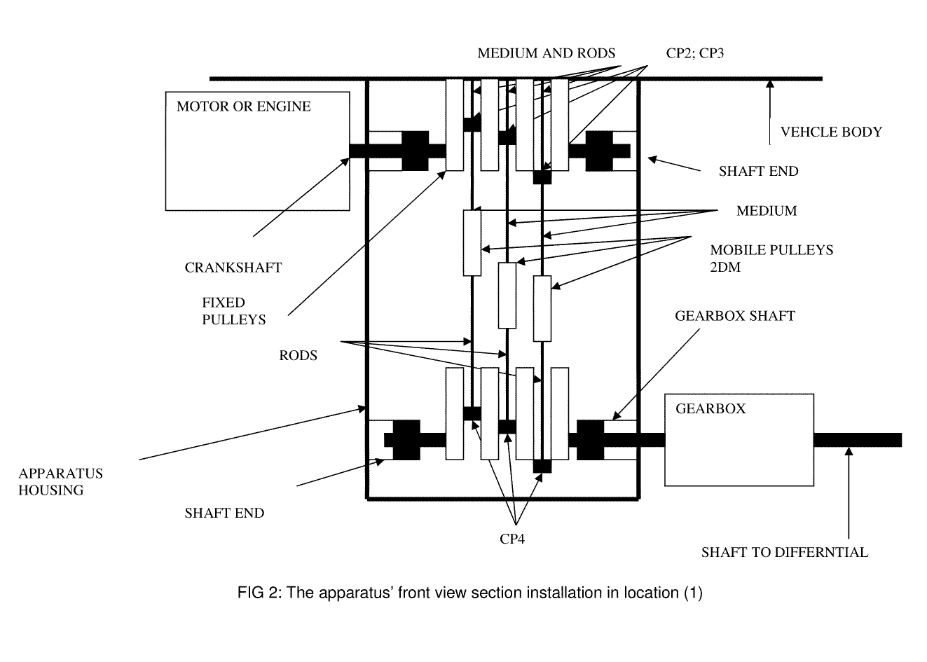

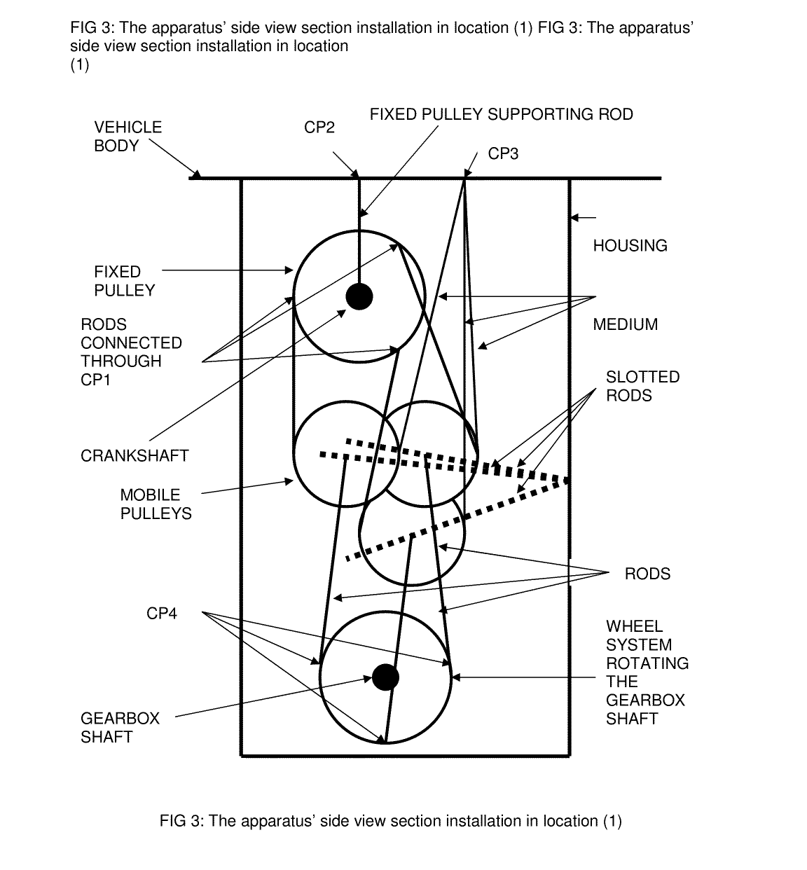

The apparatus include at least the following items: apparatus housing, transmission medium, connection bushings, connection rods, fixed and mobile pulleys. The means for controllably coupling the rotational energy required is comprised at least of the following items: the medium, whose circuit or run (for each one of the fixed and mobile pulley sets) starts from a wheel system appropriately attached to the vehicle's crankshaft for this purpose identified as “WS”. See FIG. 2. The medium is connected to these wheels through freely rotating bushing assembles or otherwise suitable rotational connection device (“bushing”) identified as “CP1” which allow for a two-dimensional rotational movement. See FIG. 2. It then continues over one wheel of the fixed pulley then further over one corresponding wheel of the mobile pulley to eventually reach an end fixed connection point on apparatus' housing which is permanently and rigidly connected to the vehicle's body or carriage identified as CP3. See FIG. 2. A rigid rod or otherwise suitable connection device (“rod”) connected through a similar freely rotating bushing assembly identified as “CP4” makes the connection or link between the mobile pulley shaft and the gearbox's shaft where a wheel system is attached. See FIG. 2. These bushings allow for a two-dimensional rotational movement of the rod. To achieve the transmission of the rotational movement from the vehicle's crankshaft to the gearbox's shaft one medium and one rod are required for each fixed pulley and corresponding mobile pulley, respectively. The fixed pulley assembly is affixed to the apparatus' housing through a rod fitted with bushings at each end, identified as “CP1” at the fixed pulley wheel and “CP2” at the connection point with the apparatus' housing. See FIG. 2. The purpose of these bushings is to allow for a two-dimensional rotational or swinging movement of the fixed pulley during operation and to eliminate any vibrations generated during the same operation of the said vehicle or device. The mobile pulley assembly is connected to the apparatus' housing through the use of slotted rods identified as “SR” which allow for a stable and consistent two-dimensional swinging and concomitantly up-and-down movement of the mobile pulley during operation, and through the use of bushing which allows for a two-dimensional rotational movement of the medium at its connection point with the apparatus' housing. See FIG. 2. Each slotted rod is affixed to the apparatus' housing through the use of a bushing identified as “CP5” which allows for at least a two-dimensional rotational or swinging movement of the slotted rods. See FIG. 3. Each of the mobile pulley wheels are connected to the gearbox's shaft wheel system through a rigid rod or otherwise suitable connection element. The rods' connection to the mobile pulley shaft and gearbox shaft's wheel system is achieved through the use of the same type of bushing assemblies described supra. The fixed and mobile pulley wheels' material, size and strength vary with and are selected according to the vehicle's purpose, size and weight.

### Use of the Apparatus in Location “(1)”

The rotational movement of the vehicle's crankshaft engages the rotation of the fixed pulley's wheels, once every 360 degrees. The rotation of the fixed pulley's wheels is transmitted through the medium to the corresponding mobile pulley wheel which, concomitantly, engages itself into a linear movement along with its affixed rod. See FIG. 2. The two-dimensional movement of the mobile pulley (identified as “2DM” on FIG. 2) is thus converted by the operation of its affixed rod into a rotational movement (identified as “RM” on FIG. 2) of the vehicle's gearbox flywheel. Due to the 120 degrees phasing of the three fixed and mobile pulley assemblies, the same process occurs for each of the fixed pulley and mobile pulley assemblies, once every 360 degrees. This repetitive cycle ensures the continuous and consistent rotational movement of the gearbox's shaft. On current vehicles, which are not equipped with the apparatus, the rotational force required at the motor or vehicles' crankshaft to achieve the operating rotation of the gearbox' shaft is “F”. According to the principle of physics detailed above the installation at least one apparatus between the vehicle's crankshaft and the gearbox's shaft reduces the previously required rotational force (at the vehicle's engine or motor's crankshaft) by at least 50% (fifty percent), from “F” to “F/2.”

### Process of Making the Apparatus for Use into Location “(2)”

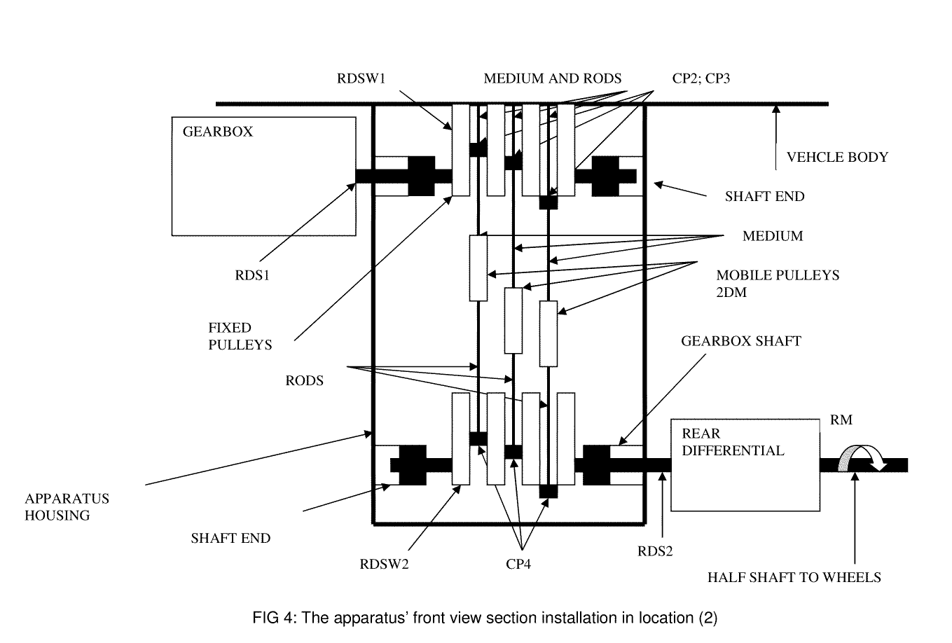

The apparatus's component parts include at least the same items as the ones employed by the apparatus under location (1) described above. To introduce at least one apparatus into this location the vehicle's rear drive shaft shall be comprised of at least two segments: one operating from the vehicle's gearbox shaft to the apparatus (identified as “RDS1” on FIG. 4) and one operating from the apparatus to the vehicle's rear differential (identified as “RDS2” on FIG. 4). To achieve the operability of the apparatus RDS1 must be fitted with at least one wheel system at the vehicle's gearbox shaft end (identified as “RDSW1” on FIG. 4). Similarly, RA2 must be fitted with at least one wheel system at the end opposite the vehicle's rear differential shaft end (identified as “RDSW2” on FIG. 4). The medium's circuit or run for each of the fixed and corresponding mobile pulley sets starts from RDSW1 where it is connected to a freely two-dimensional rotating bushing identified as “CP1”. See FIG. 4. Same as for the apparatus installed in location (1) it then the continues over one wheel of the fixed pulley which is permanently affixed to the apparatus' housing through a two-dimensionally rotating bushing identified as “CP2”. See FIG. 4. The medium then runs over one corresponding wheel of the mobile pulley set, and then reaches the end connection point on the apparatus' housing through a bushing identified as “CP3”. See FIG. 4. Same as under location (1), a rigid rod connected through freely two-dimensionally rotating bushings makes the connection between the mobile pulley shaft and one of the connection points (“CP4”) on the shaft's wheel RDSW2. See FIG. 4. To achieve the transmission of the rotational movement from RDSW1 one medium and one rod respectively are required for each fixed and corresponding mobile pulley assemblies. Same as with the apparatus introduced in location (1) the fixed pulley assembly is affixed to the housing through a bushing which allows the pulley's holding rod to swing freely in a two-dimensional plane. The mobile pulley assembly is connected, similarly as under location (1), to the apparatus' housing through the use of similar longitudinally slotted rods, one corresponding to each wheel of the mobile pulley set. The role and manner of connection of the slotted rods is identical to that described for the apparatus' installation in location (1). Each one of the mobile pulley wheels are connected to RDSW2 wheel system through a rigid rod required to convert the two-dimensional up-and-down and swinging movement of the mobile pulleys into a two-dimensional rotation of RDSW2 and thus the shaft it is rigidly affixed to. The rods' physical connection to the mobile pulley shaft and RDSW2 wheel system is achieved through the use of bushing identical to the ones previously described.

### Use of the Apparatus Introduced in Location “(2)”

The rotational movement of the vehicle's crankshaft engages the rotation of the vehicle's first segment of the rear drive shaft to which RDSW1 is affixed. RDSW1's rotational movement then engages the fixed pulley's wheels through the medium connected to it, cyclically for the same fixed pulley wheel once every 360 degrees. Further, the medium engages the corresponding mobile pulley wheel which, concomitantly, engages itself into an up-and-down and swinging two dimensional movement along with the affixed rod #2. The two-dimensional movement of the mobile pulley is thus converted through the two-dimensional movement of rod #2 into a rotational movement (identified as “RM” on FIG. 4) of RDSW2 which is rigidly affixed to the second segment of the vehicle's rear drive shaft. Due to the 120 degrees phasing of the three fixed and mobile pulley assemblies (this angle varies according with the number of fixed and mobile pulleys selected), the same process cyclically occurs for each of the fixed pulley and mobile pulley wheels, once every 360 degrees. This repetitive cycle ensures the continuous and consistent rotational movement of RDSW2. Thus, the vehicle's rear drive shaft segment RDS 2 will operate the rear traction wheels through the rear differential in the same manner it previously did prior to installing the apparatus in location (2). According to the principle of physics detailed above, the installation of at least one apparatus between the vehicle's gearbox shaft and the said vehicle's rear differential reduces the previously required rotational force at the vehicle's crankshaft by at least 50% (fifty percent), from “F” to at least “F/2.” NOTE: When one apparatus are installed in location (1) and one apparatus in location (2) the cumulative use effect is as follows: the apparatus installed in location (1) reduces the previously required rotational force at the vehicle's engine or motor crankshaft from F to F/2. The apparatus installed in location (2) further reduces the force F/2 to F/2/2 or F/4. As a result, the rotational force or energy now required to rotate the vehicle's crankshaft is proportionally reduced by 75% (seventy five percent) of that required prior to the installation of the apparatus in locations (1) and (2).

### Process of Making for an Apparatus for Use into Location “(2)”

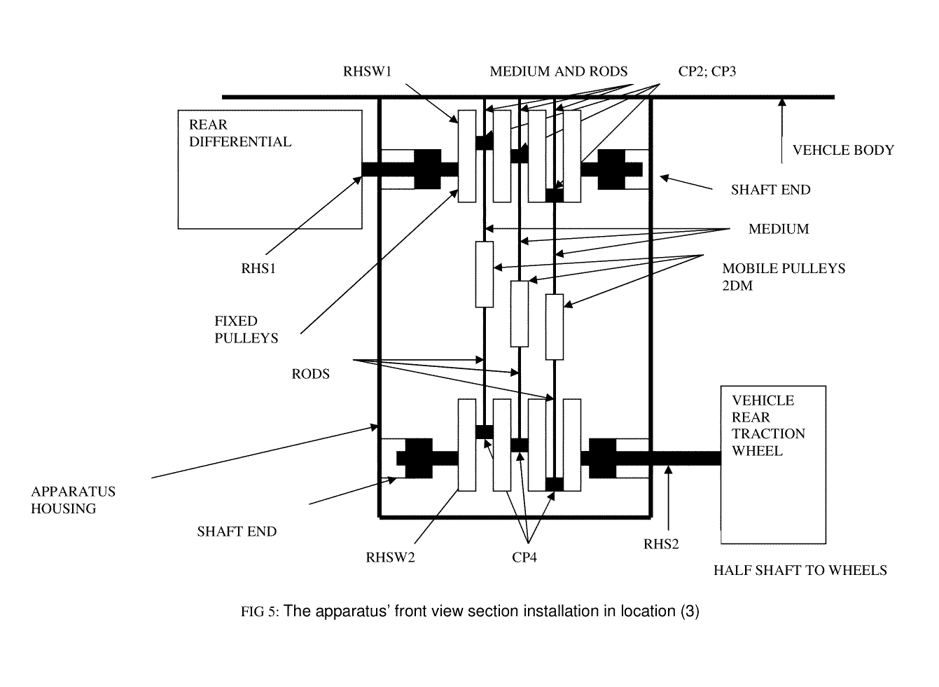

The apparatus' introduction into this vehicle location requires that at least one of the vehicle's wheel rear half shafts be divided into two segments: one running and operating from the vehicle's rear differential to the apparatus' installation location (identified as “RHS1” on FIG. 5) and one running and operating from the apparatus' installation location to the vehicle's rear wheel (identified as “RHS2” on FIG. 5). Same as for the apparatus installation described under “Process of making for a apparatus introduced in location “(2)” RHS1 must be fitted with an appropriate wheel system at the end opposite the vehicle's rear differential (identified as “RHSW1” on FIG. 5). Similarly, RHS2 is fitted with an appropriate wheel system at the end opposite the vehicle's rear wheel (identified as “RHSW2” on FIG. 5). The installation of the fixed and mobile pulley sets as well as the medium's run or circuit and the manner of its connection to the housing or the vehicle's body or chassis and to RHSW1 and RHSW2 are the same as for those described under section 10.

### Use of the Apparatus for Use into Location “(3)”

The use of the apparatus installed in location (3) is the same as the use of the apparatus installed in location (2), as described under section 10. NOTE: When at least one apparatus is installed in all three locations: location (1), location (2) and location (3), the cumulative use effect is as follows: the apparatus installed in location (1) reduces the previously required rotational force at the vehicle or motor's crankshaft from F to F/2. Then, the apparatus installed in location (2) further reduces the force from F/2 to F/2/2 or F/4. Then, the apparatus installed in location (3) reduces the force from F/4 to F/4/2, or F/8. Thus, the use of the apparatus in locations (1), (2) and (3) reduces the rotational force previously required to rotate the vehicle's engine or motor crankshaft from “F” to at least “F/8”, or by at least 87.5% (eighty seven point five percent).

### Process of Making the Apparatus for Use into Location “(4)”

The apparatus's component parts include at least the same items as the ones employed by the apparatus under location (1) described above. Each one of these items are readily available and shall be specified, sized and selected based on the vehicle's type and purpose, size and weight such that they withstand the conditions known to be associated with the vehicle's or device's operation. To introduce the apparatus into this vehicle or device location the front drive shaft shall be divided into at least two segments: one running and operating from the vehicle or device gearbox's transfer case to the apparatus (identified as “FHS1” on FIG. 4) and one running from the apparatus to the vehicle's front differential (identified as “FHS2” on FIG. 4). To achieve the operability of the apparatus FHS1 must be fitted with a wheel system at the end opposite the vehicle's gearbox (identified as “FHSW1” on FIG. 4). Similarly, FHS2 must be fitted with a wheel system at the end opposite the vehicle's rear differential (identified as “FHSW2” on FIG. 4). The medium's circuit or run (for each of the fixed and mobile pulley sets) starts from FHSW1 where it is connected to a freely two-dimensional rotating bushing (“CP1”). Same as for the apparatus installed in location (1) it then the continues over one wheel of the fixed pulley (which is permanently affixed to the housing or to the vehicle's body or chassis through a two-dimensionally rotating bushing “CP2”), then over one corresponding wheel of the mobile pulley set, and then reaches the end connection point on the apparatus' housing (“CP3”). See FIG. 4. A rigid rod connected through freely rotating bushings makes the link between the mobile pulley shaft and one of the connection points on FHSW2 (“CP4”). The connecting bushings allow for a two-dimensional movement of the rod. To achieve the transmission of the rotational movement from FHSW1 one medium and one rod respectively are required for each fixed and corresponding mobile pulley assemblies. Same as for the apparatus introduced in location (1) the fixed pulley assembly is affixed to the housing or to the vehicle's body or chassis though a bushing assembly which allows the pulley's holding arm to move and swing freely in a two-dimensional plane. The mobile pulley assembly is connected, similarly as under location (1) to the housing or to the vehicle's body or chassis through the use of longitudinally slotted rods, one corresponding to each wheel of the mobile pulley set. The role of the rod's longitudinal slot is to allow for a back and forth movement of the mobile pulley during its operation. Each slotted rod is affixed at one end to the apparatus' housing through the same type of bushing described above allowing for a 2-dimensional movement of the rod. The rod's two-dimensional movement is required during the operation of the vehicle. Each of the mobile pulley wheels are connected to FHSW2 through a rigid rod. The rods' physical connection to the mobile pulley shaft and FHSW2 is achieved through the use of bushings identical to the ones described above.

### Use of the Apparatus Introduced into Location “(4)”

The rotational movement of the vehicle's crankshaft engages through the transfer case the rotation of front drive shaft's first segment to which FHSW1 is affixed. FHSW1's rotational movement then engages the fixed pulley's wheels through the medium connected to it, cyclically for the same fixed pulley wheel once every 360 degrees. Further, the medium engages the corresponding mobile pulley wheel which, concomitantly, engages itself into a linear movement along with the affixed rod #2. The linear movement of the mobile pulley (identified as “LM” on FIG. 4) is thus converted through the 2-dimensional movement of rod #2 into a rotational movement (identified as “RM” on FIG. 4) of FHSW2 affixed to the second segment of the front drive shaft. Due to the 120 degrees phasing of the three fixed and mobile pulley assemblies (this angle varies according with the number of fixed and mobile pulleys selected), the same process cyclically occurs for each of the fixed pulley and mobile pulley wheels, once every 360 degrees. This repetitive cycle ensures the continuous and consistent rotational movement of FHSW2. Thus, the vehicle's front drive shaft segment FHS2 will operate the front traction wheels through the front differential in the same manner it previously did prior to installing the apparatus in location (4). According to the principle of physics detailed above, the installation of at least one apparatus in location “(4)” reduces by 50% (fifty percent) the previously required rotational force at the vehicle's engine or motor's crankshaft, from “F” to “F/2.” NOTE: If apparatuses are installed in both location (1) and (2), the apparatus installed in location (1) reduces the previously required rotational force at the vehicle's engine crankshaft from F to F/2 and the apparatus installed in location (4) further reduces the force F/2 to F/2/2 or F/4. Thus, the rotational force or energy required to rotate the vehicle's crankshaft is now reduced by 75% of that required prior to the installation of the apparatuses in locations (1) and (4).

1. (canceled)

2. The apparatus or plurality of apparatuses installed between an internal combustion, or electric, or solar, or nuclear, or hybrid, or fuel cell vehicle's gearbox and the said vehicle's rear differential reduces the amount of energy, electricity or fuel required for the self-propelling function of the said vehicle by at least 50%.

3. The apparatus or plurality of apparatuses installed between an internal combustion, or electric, or solar, or nuclear, or hybrid, or fuel cell vehicle's rear differential and the said vehicle's rear traction wheels or front differential and the said vehicle's front traction wheels reduces the amount of energy, electricity, or fuel required for the self-propelling function of the said vehicle by at least 50%.

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. The apparatus or plurality of apparatuses installed in a wind-powered generating device between the rotor blades' shaft and the device's gearbox shaft reduces the amount of rotational force or energy required for the rotation of the generator's shaft by at least 50%.

28. (canceled)

29. (canceled)

30. (canceled)

31. (canceled)
